(19) United States
(12) Patent Application Publication
(10) Pub. No.: US 2016/0087934 A1
(43) Pub. Date: Mar. 24, 2016

(54) COMMUNICATION SYSTEM, COMMUNICATION METHOD, AND TRANSMISSION APPARATUS

(71) Applicant: FUJITSU LIMITED, Kawasaki-shi (JP)

(72) Inventors: Ryoichi Mutoh, Kawasaki (JP); Naoki Oguchi, Kawasaki (JP)

(21) Appl. No.: 14/812,548

(22) Filed: Jul. 29, 2015

(30) Foreign Application Priority Data
Sep. 18, 2014 (JP) 2014-189524

(51) Int. Cl. H04L 29/12; H04L 12/741

(52) U.S. Cl. CPC H04L 61/2007; H04L 45/74

(57) ABSTRACT

A communication system includes: a communication apparatus; and a transmission apparatus configured to transmit a packet to be transmitted from the communication apparatus to a transmission destination, wherein the communication apparatus transmits, to the transmission apparatus, a first request signal for requesting a start of a communication with the transmission destination and a second request signal for requesting the start of the communication with the transmission destination with passing through the transmission apparatus, and wherein, when a request of the first request signal is permitted, the transmission apparatus notifies the communication apparatus of that a request of the second request signal is not permitted, and transmits the first request signal to the transmission destination, and the communication apparatus receives a response to the first request signal from the transmission destination and starts communication with the transmission destination without passing through the transmission apparatus.

### CROSS-REFERENCE TO RELATED APPLICATION

This application is based upon and claims the benefit of priority of the prior Japanese Patent Application No. 2014-189524, filed on Sep. 18, 2014, the entire contents of which are incorporated herein by reference.

### FIELD

The embodiments discussed herein are related to a communication which is performed among a plurality of communication apparatuses.

### BACKGROUND

When a plurality of apparatuses communicate with each other, a transmission control protocol (TCP) is generally used and in the communication using the TCP, when a packet is discarded once, a communication speed significantly decreases, and as a result, it is difficult to improve a throughput. On this account, in the case where a round trip time (RTT) is relatively long as in a communication between overseas bases or in a communication that passes through a network in which packet discard rate is high as in a wireless network, the efficiency easily deteriorates when the TCP is used. Therefore, cases have increased in which a speed of data transmission is enhanced by using a wide area network (WAN) accelerating devices. The WAN accelerating devices are installed at both terminals of a client side and a server side of the network. The WAN accelerating device that receives a TCP packet from a client apparatus converts a protocol used in the packet into a high-speed protocol and thereafter, transmits the high-speed protocol to the WAN accelerating device at the server side. The WAN accelerating device at the server side converts the packet received from the WAN accelerating device at the client side into the TCP packet and thereafter, transmits the TCP packet to the server.

However, in a network between a transmission source and a transmission destination of the packet, when the round trip time is relatively short and the packet discard rate is low, it may be anticipated that even communication not using the high-speed protocol has relatively high communication performance. In this case, there is a case that a period when the packet reaches the transmission destination from the transmission source is shorter in a scheme of transmitting the packet without converting the protocol than in the scheme of converting the protocol by using the WAN accelerating device. Therefore, when the accelerating of the transmission by the conversion of the protocol cannot be anticipated, the packet may be transmitted without converting the protocol in the WAN accelerating device. Accordingly, according to a route to the transmission destination from the transmission source of data, it is attempted that the WAN accelerating device decides a transmission policy regarding whether to perform the transmission processing using the high-speed protocol and information decided in the WAN accelerating device is acquired at the transmission source.

FIG. 1 is a diagram illustrating an example of a method for acquiring the transmission policy from the WAN accelerating device. The case of C1 of FIG. 1 illustrates an example of a case in which a redirector 11 of a client apparatus 7 requests the transmission policy to a WAN accelerating device 5 and the transmission policy 16 is notified to the client apparatus 7 as a response from the WAN accelerating device 5. A case C2 illustrates an example of a case in which the WAN accelerating device 5 periodically distributes the transmission policy to the client apparatus 7. Even in any one of the cases C1 and C2, the redirector 11 does not transmit the packet to the WAN accelerating device 5 as indicated by arrow A with respect to communication in which it is notified that the transmission not using the high-speed protocol is not performed. Meanwhile, the redirector 11 transmits a packet used in communication in which it is notified that the transmission using the high-speed protocol is performed to the WAN accelerating device 5 through a destination network address translation (DNAT) 13 as indicated by arrow B. In the WAN accelerating device 5, the transmission by the high-speed protocol is performed through processing in a kernel 15 and a high-speed protocol processing unit 17.

As for the related art, proposed is a system including a WAN accelerating device that performs, when receiving a packet which is a transmission target to a WAN, but not a priority control target from the strongpoint, accelerating processing of the received packet and thereafter, transmits the corresponding packet to a band control device. In this conventional system, the band control device allocates a band by using the packet received from the WAN accelerating device (see, e.g., Japanese Laid-Open Patent Publication No. 2013-34063). Further, modifying a description message is also contrived based on a result of comparing an option tag representing a potential setup regarding a media session in a description message exchanged between nodes with a supported setup (see, e.g., Japanese Laid-Open Patent Publication No. 2012-506664). Proposed is also a system in which a controller that performs a flow control of the node calculates a route which does not pass through a designated bypassing node to set up flow information in a node forming the route (see, e.g., International Publication Pamphlet No. WO2011/043379).

### SUMMARY

According to an aspect of the invention, a communication system includes: a communication apparatus configured to generate a first request signal and a second request signal, each requesting a start of a communication with a transmission destination; and a transmission apparatus configured to transmit a packet to be transmitted from the communication apparatus to the transmission destination, wherein the communication apparatus transmits the first request signal and the second request signal to the transmission apparatus, the second request signal requesting the start of the communication with the transmission destination with passing through the transmission apparatus, and wherein, when a request of the first request signal is permitted, the transmission apparatus notifies the communication apparatus of that a request of the second request signal is not permitted, and transmits the first request signal to the transmission destination, and the communication apparatus receives a response to the first request signal from the transmission destination and starts communication with the transmission destination without passing through the transmission apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a method of acquiring a transmission policy from a WAN accelerating device;

FIG. 2 is a diagram illustrating an example of a method according to an embodiment;

FIG. 3 is a diagram illustrating an example of a configuration of a communication apparatus;

FIG. 4 is a diagram illustrating an example of a configuration of a transmission apparatus;

FIG. 5 is a diagram illustrating an example of a configuration of hardware;

FIG. 6 is a diagram illustrating an example of a network;

FIG. 7 is a sequence diagram illustrating an example of a communication process performed in a first embodiment;

FIG. 8 is a diagram illustrating an example of a transmission policy;

FIG. 9 is a diagram illustrating an example of a transmission policy table;

FIG. 10 is a diagram illustrating an example of an accelerating target table;

FIG. 11 is a flowchart for describing an example of a process in which a transmission apparatus transmitting an SYN packet is performed;

FIG. 12 is a flowchart for describing an example of a process in which a transmission apparatus transmitting an RST packet is performed;

FIG. 13 is a sequence diagram illustrating an example of a communication process performed in a second embodiment;

FIG. 14 is a diagram illustrating an example of a transmission policy;

FIG. 15 is a diagram illustrating an example of a format of a packet transmitted through a GRE tunnel;

FIG. 16 is a diagram illustrating an example of a source conversion table;

FIG. 17 is a diagram illustrating an example of a transmission policy table used in a third embodiment;

FIG. 18 is a sequence diagram illustrating an example of a communication process performed in the third embodiment;

FIG. 19 is a diagram illustrating an example of an accelerating target table;

FIG. 20 is a diagram illustrating an example of a transmission policy table used in a fourth embodiment;

FIG. 21 is a sequence diagram illustrating an example of a communication process performed in the fourth embodiment; and

FIG. 22 is a diagram illustrating an example of an accelerating target table.

### DESCRIPTION OF EMBODIMENTS

When a communication apparatus requires transmission of policy information to a WAN accelerating device and determines whether data transmitted to a transmission destination is transmitted to the WAN accelerating device according to an acquired transmission policy, the communication apparatus does not transmit the data from the communication apparatus to a transmission destination but stands by until the transmission policy is received. As a result, it takes time for a process for transmitting the data. Meanwhile, in the case where the WAN accelerating device periodically distributes the transmission policy, after the transmission policy is changed and before the new transmission policy is transmitted, the communication may not be performed on a proper route when the communication apparatus starts communication.

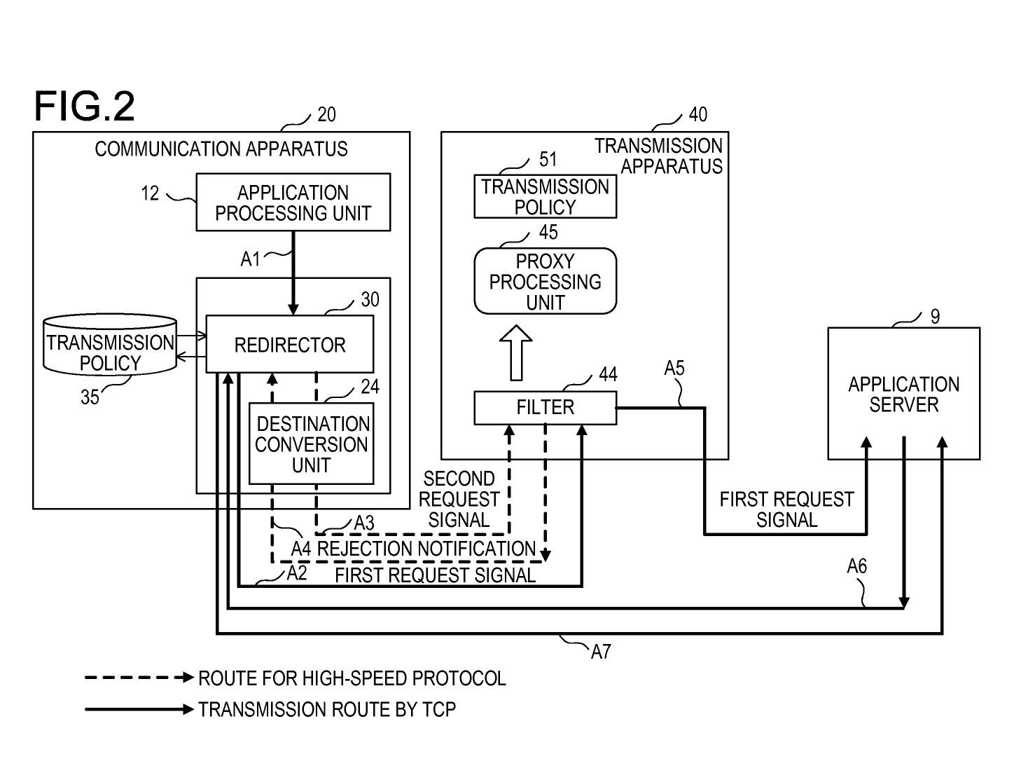

Thereafter, an embodiment of a technique of shortening a time taken to establish the communication on the proper route will be described with reference to the accompanying drawings. FIG. 2 illustrates an example of a method according to an embodiment. A transmission apparatus 40 illustrated in FIG. 2 may operate as the WAN accelerating device. Hereinafter, a case where the communication apparatus 20 starts to communicate with an application server 9 will be described as an example of a communication process performed by a method according to an embodiment.

As illustrated in arrow A1, first, in the communication apparatus 20, an application processing unit 12 generates a request signal which requests communication with the application server 9 in order to establish the communication with the application server 9. Here, as the request signal, for example, a synchronize packet (SYN packet) in which a synchronize bit (SYN bit) value is set to 1 among flag bits of a TCP header may be used. The generated request signal is input to a redirector 30.

The redirector 30 duplicates the input request signal. The redirector 30 transmits one request signal (a first request signal) to the transmission apparatus 40 (arrow A2). A destination conversion unit 24 transmits the duplicated request signal to the transmission apparatus 40 to convert the duplicated request signal into a second request signal for requesting a start of the communication with the application server 9 through the transmission apparatus 40. Further, the communication apparatus 20 transmits the second request signal to the transmission apparatus 40 (arrow A3).

A filter 44 of the transmission apparatus 40 receives the first and second request signals transmitted from the communication apparatus 20. The filter 44 determines whether the communication with the application server 9 through the transmission apparatus 40 is permitted with respect to the communication apparatus 20 by using a transmission policy 51. In the transmission policy 51, information representing whether the packet is transmitted to the application server 9 by using a high-speed protocol is included. When information for indicating the transmission of the packet to the application server 9 by using the high-speed protocol is not included in the transmission policy 51, the filter 44 transmits a packet for notifying the rejection of the communication to the communication apparatus 20 as a response for the second request signal (arrow A4). For example, when non-transmission of the packet to the application server 9 by using the high-speed protocol is included in the transmission policy 51, the filter 44 may transmit a reset (RST) packet to the communication apparatus 20 as a response for the second request signal. Here, the RST packet is a packet in which the value of the RST bit among the flag bits in the TCP header is set to 1.

In the arrow A4, when the rejection for the communication requested by using the second request signal is notified from the transmission apparatus 40, the redirector 30 determines that the packet to the application server 9 is not transmitted to the transmission apparatus 40. In addition, the redirector 30 records in a transmission policy table 35, that the packet to the application server 9 is not transmitted to the transmission apparatus 40. As a result, in a subsequent process, the packet to the application server 9 is not transmitted to the transmission apparatus 40.

In arrow A5, the filter 44 transmits the first request signal to the application server 9, when information for indicating the transmission of the packet to the application server 9 by using the high-speed protocol is not included in the transmission policy 51. Meanwhile, in the first request signal, since a transmission source is set as the communication apparatus 20 and the transmission destination is set as the application server 9, the application server 9 determines that the first request signal is received from the communication apparatus 20.

In arrow A6, the application server 9 requests starting of communication to the communication apparatus 20 from the application server 9 in addition to permission of communication in a direction to the application server 9 from the communication apparatus 20, with respect to the first request signal. As a signal of arrow A6, for example, an SYN/ACK (synchronize/acknowledge) packet of the TCP may be used.

When the signal of the arrow A6 is received, the communication apparatus 20 uses a route which does not pass through the transmission apparatus 40 as illustrated in arrow A7 for communication with the application server 9. Thereafter, in the communication to the application server 9 from the communication apparatus 20, a route illustrated in arrow A7 is used, and in the communication to the communication apparatus 20 from the application server 9, a route illustrated in arrow A6 is used.

As such, the transmission apparatus 40 notifies the communication apparatus 20 of the rejection of the communication to with respect to a signal which is contrary to the content of the transmission policy 51 determined by the transmission apparatus 40 of the first and second request signals transmitted to the transmission apparatus 40 from the communication apparatus 20. For this reason, even though the communication apparatus 20 starts the communication without waiting an acquisition of the transmission policy determined in the transmission apparatus 40, the communication apparatus 20 may start communication suitable for the transmission policy.

When the communication with the application server 9 is rejected by the transmission apparatus 40, the transmission apparatus 40 transmits a request signal (first request signal) to the application server 9, to the application server 9. For this reason, even though the communication with the application server 9 through the transmission apparatus 40 is rejected, the communication apparatus 20 may start communication with the application server 9.

Hereinafter, the case where the communication apparatus 20 starts the communication with the application server 9 is described as an example, but a transmission destination of the communication apparatus 20 may be any apparatus other than the application server 9.

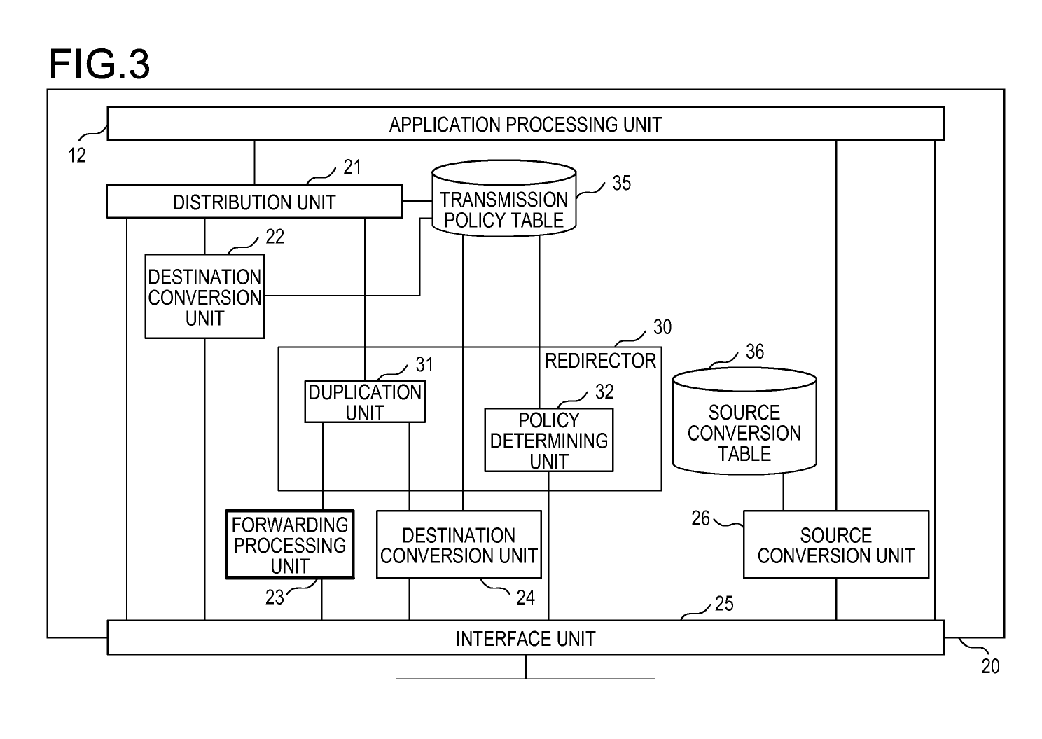

FIG. 3 is a diagram illustrating an example of a configuration of the communication apparatus 20. The communication apparatus 20 includes an application processing unit 12, a distribution unit 21, a destination conversion unit 22, a forwarding processing unit 23, a destination conversion unit 24, an interface unit 25, a source conversion unit 26, a redirector 30, a transmission policy table 35, and a source conversion table 36. The redirector 30 has a duplication unit 31 and a policy determining unit 32.

The application processing unit 12 operates as an application client. That is, the application processing unit 12 generates a communication request for starting the communication by performing a process using an application. The distribution unit 21 classifies a packet according to a kind of transmission packet. The distribution unit 21 outputs a request signal to the duplication unit 31 by referring to the transmission policy table 35. With respect to the packet other than the request signal, the distribution unit 21 outputs the packet transmitted to the transmission apparatus 40 to the destination conversion unit 22 by referring to the transmission policy table 35 to output a packet transmitted without passing through the transmission apparatus 40, to the interface unit 25. An example of the transmission policy table 35 will be described below. The destination conversion unit 22 performs a conversion processing for the transmission destination in order to transmit the input packet to the transmission apparatus 40.

The duplication unit 31 duplicates the request signal when the request signal for requesting a start of the communication to the application server 9 is received. The duplication unit 31 outputs one request signal acquired by duplication to the forwarding processing unit 23 and the other request signal to the destination conversion unit 24. The forwarding processing unit 23 performs a transmission processing for transmitting the input request signal to the transmission apparatus 40 as the first request signal for requesting the start of the communication to the application server 9. A process in the forwarding processing unit 23 will be described below in detail. The destination conversion unit 24 changes, for example, an IP address of the input request signal to, for example, an address of the transmission apparatus 40 to generate a second request signal for requesting the communication with the application server 9 through the transmission apparatus 40 to the transmission apparatus 40. The interface unit 25 transmits a packet input from the distribution unit 21, the destination conversion unit 22, the forwarding processing unit 23, and the destination conversion unit 24. Further, the interface unit 25 outputs the packet received from another apparatus to the application processing unit 12, the policy determining unit 32, or the source conversion unit 26.

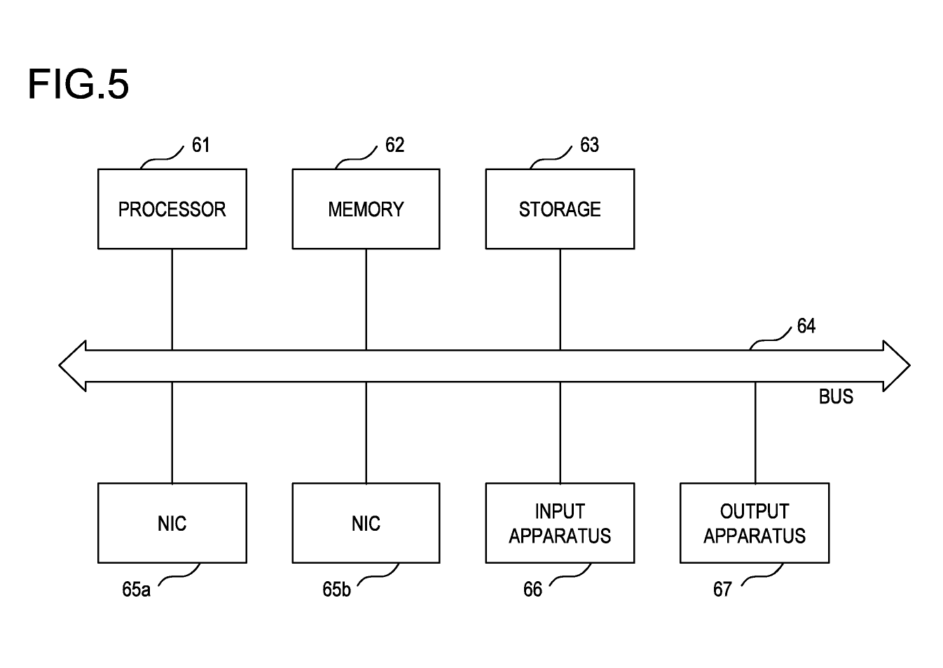

The policy determining unit 32 maintains the transmission policy in a format which may be used for the processing of the distribution unit 21 when acquiring notification of the communication rejection transmitted from the transmission apparatus 40. For example, the policy determining unit 32 may change the transmission policy table 35 by using the acquired information. Further, the policy determining unit 32 does not record the acquired information in the transmission policy table 35 and may also cache the acquired information in a memory (see, e.g., FIG. 5) as additional information of the transmission policy table 35. The source conversion unit 26 acquires a packet other than the notification of the communication rejection transmitted from the transmission apparatus 40 and converts an address of the transmission source and the like by using the source conversion table 36.

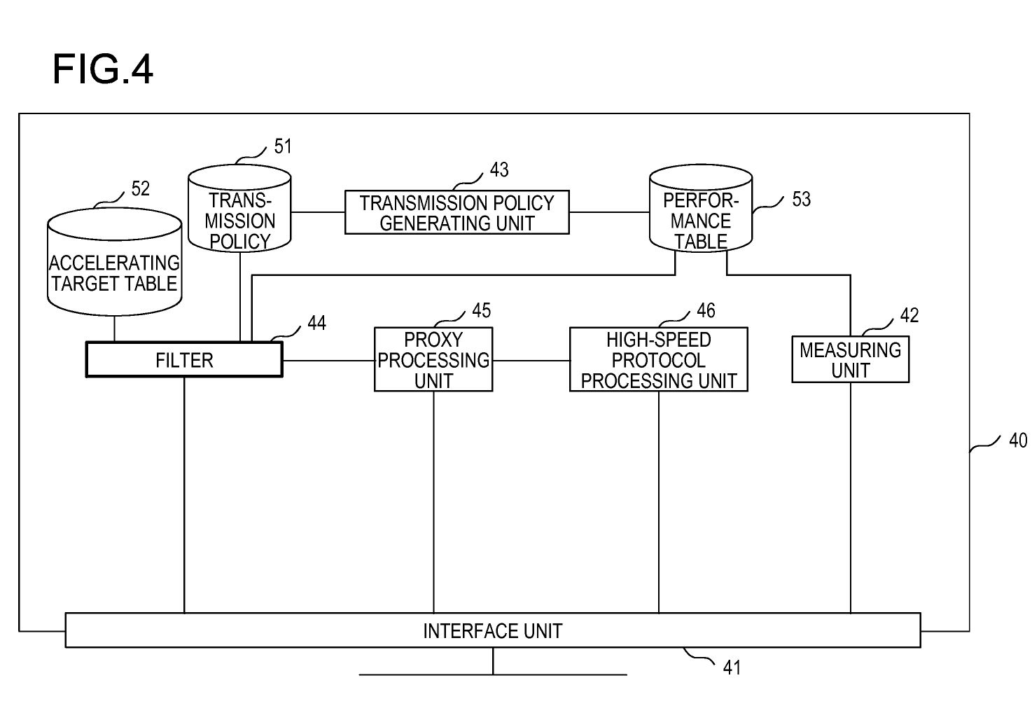

FIG. 4 is a diagram illustrating an example of a configuration of the transmission apparatus 40. The transmission apparatus 40 includes an interface unit 41, a measuring unit 42, a transmission policy generating unit 43, a filter 44, a proxy processing unit 45, a high-speed protocol processing unit 46, a transmission policy 51, an accelerating target table 52, and a performance table 53.

The interface unit 41 transmits and receives the packet between other apparatuses. The measuring unit 42 measures communication quality of a line between the transmission apparatus 40 which is a transmission destination of the packet using the high-speed protocol. The measuring unit 42 records the communication quality acquired by measuring in the performance table 53. In this case, the measuring unit 42 may record the communication quality in the performance table 53 in response to information of a burst size of the application used in the communication processing of the communication apparatus 20 or a communication interval. The transmission policy generating unit 43 determines the transmission policy 51 representing whether the high-speed protocol is used by using the performance table 53 or the information of the used application. In the accelerating target table 52, information of connection which is a target determining whether the high-speed protocol is used is recorded. An example of the accelerating target table 52 will be described below.

The filter 44 notifies the rejection of the communication start to the communication apparatus 20 in response to a signal requesting the start of the communication which does not follow the transmission policy 51, of the first request signal and the second request signal specified from the accelerating target table 52. Further, the filter 44 operates as the controller for the transmission processing of the first request signal when the communication using the high-speed protocol is not permitted. The proxy processing unit 45 terminates a protocol other than the high-speed protocol such as, for example, the TCP used in the packet with respect to a reception packet which is a target of the processing using the high-speed protocol. The high-speed protocol processing unit 46 processes the input packet by using the high-speed protocol. Meanwhile, the high-speed protocol is any protocol which may be used for an accelerating process for communication in the TCP.

FIG. 5 is a diagram illustrating an example of a configuration of hardware. Either the communication apparatus 20 or the transmission apparatus 40 includes a processor 61, a memory 62, a bus 64, and a network interface card (NIC) 65 (65a and 65b). The processor 61 properly reads a program from the memory 62 and executes the read program. The bus 64 is connected to the processor 61, the memory 62, and the NIC 65 to be input and output data therebetween. In FIG. 5, an example in which the two NICs 65 are included is illustrated, but either the communication apparatus 20 or the transmission apparatus 40 may have any number of NICs 65. Either the communication apparatus 20 or the transmission apparatus 40 may have a storage 63, an input device 66, and an output device 67, as an option.

In the communication apparatus 20, the processor 61 operates as the distribution unit 21, the destination conversion unit 22, the forwarding processing unit 23, the destination conversion unit 24, the source conversion unit 26, the redirector 30, and the application processing unit 12. The transmission policy table 35 and the source conversion table 36 are memorized in the memory 62. The interface unit 25 is implemented by the NIC 65 and the processor 61.

In the transmission apparatus 40, the processor 61 implements the measuring unit 42, the transmission policy generating unit 43, the filter 44, the proxy processing unit 45, and the high-speed protocol processing unit 46. The memory 62 memorizes the transmission policy 51, the accelerating target table 52, and the performance table 53 and further, properly memorizes the data used in the processor 61. The interface unit 41 is implemented by the NIC 65 and the processor 61.

### First Embodiment

Hereinafter, in order to request the start of the communication to the application server 9 by using the TCP, a first embodiment will be described with an exemplary case where the communication apparatus 20 uses the SYN packet as the request signal.

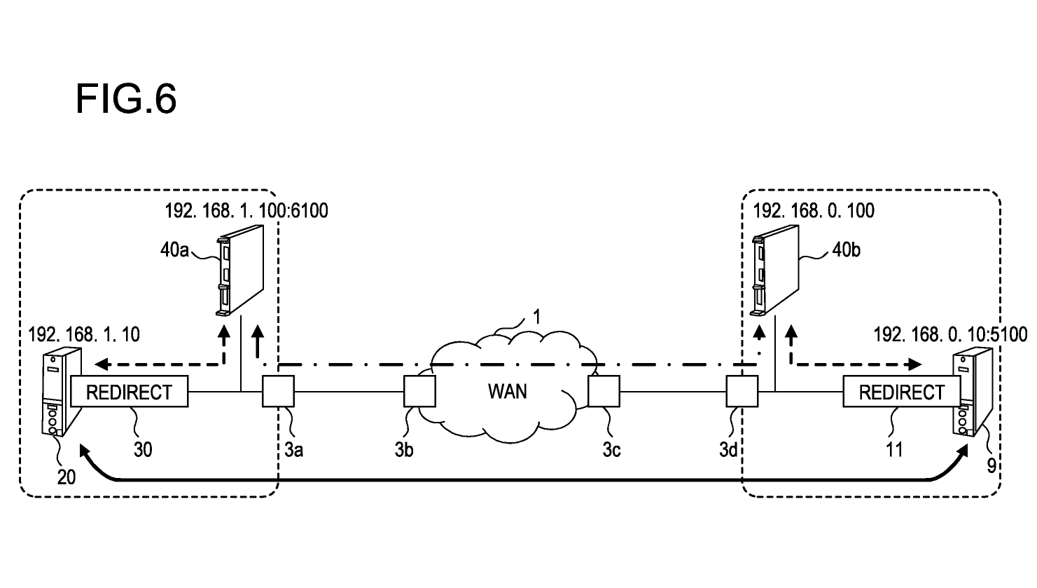

FIG. 6 illustrates an example of a network. In the description below, in a communication route between the communication apparatus 20 and the application server 9, a WAN 1 or routers 3 (3a to 3d) is included. Meanwhile, FIG. 6 is an example, and the number of routers 3 included in the communication route between the communication apparatus 20 and the application server 9 is optional. A transmission apparatus 40a is installed at the communication apparatus 20 side of the network and a transmission apparatus 40b is installed at the application server 9 side of the network. In the description below, the transmission apparatus 40a and the communication apparatus 20 belong to the same sub network. Further, the transmission apparatus 40b and the application belong to the same sub network.

When the packet transmitted/received between the communication apparatus 20 and the application server 9 is transmitted without using the high-speed protocol, as illustrated as a solid arrow of FIG. 6, between the communication apparatus 20 and the application server 9, the communication is performed without passing through the transmission apparatus 40. In the description below, a transmission method in the case where the packet transmitted/received between the communication apparatus 20 and the application server 9 is transmitted by the TCP without passing through the transmission apparatus 40 is referred to as a ‘TCP thru’ in some cases.

When the communication using the high-speed protocol is performed, the redirector 30 included in the communication apparatus 20 redirects the packet to the application server 9 to the transmission apparatus 40a. The transmission apparatus 40a installed at the communication apparatus 20 side terminates a TCP protocol and transmits the data to the application server 9 to the transmission apparatus 40b installed at the server side by using the high-speed protocol. The transmission apparatus 40b terminates the communication using the high-speed protocol and transmits the data to the application server 9 by the TCP. In this case, the transmission apparatus 40b sets information on an address or a port of the packet to the server to recognize that the application server 9 acquires the data through a TCP section formed between the communication apparatus 20 and the application server 9. The data transmission to the communication apparatus 20 from the application server 9 is processed in the same manner. Meanwhile, the transmission packet from the application server 9 is transmitted to the transmission apparatus 40b by the redirector 11. For this reason, in a region illustrated by a dash arrow of FIG. 6, the communication using the TCP is performed, but in a region illustrated by an alternated long and short dash arrow, the communication using the high-speed protocol is performed.

In the description below, an IP address of 192.168.1.10 is allocated to the communication apparatus 20, and an IP address of 192.168.1.100 is allocated to the transmission apparatus 40a. Meanwhile, a waiting TCP port in the transmission apparatus 40a is referred to as #6100 port. Further, the IP address of 192.168.0.100 is allocated to the transmission apparatus 40b and the IP address of 192.168.0.10 is allocated to the application server 9. Meanwhile, a waiting TCP port in the application server 9 is referred to as #5100 port.

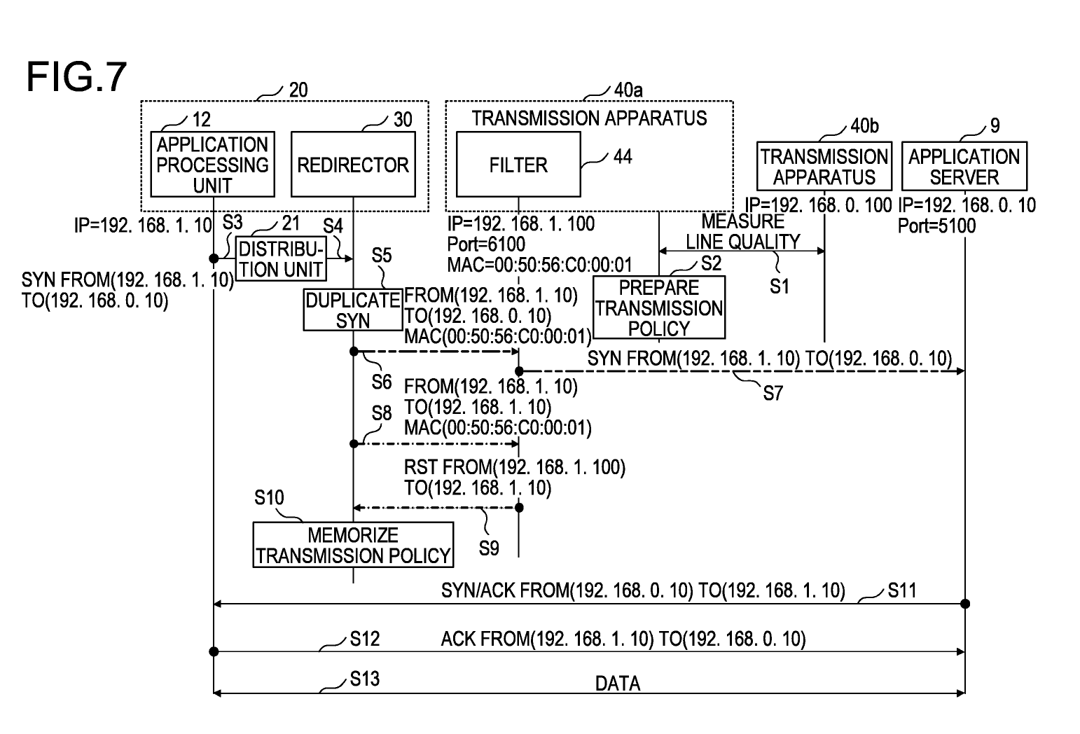

FIG. 7 is a sequence diagram illustrating an example of a communication process performed in a first embodiment. Meanwhile, a sequence illustrated in FIG. 7 is an example and may be changed according to installation. For example, operation S6, a process of S7, operation S8, and a process of S9 may be changed in a sequence, and may be performed in combination. Alternatively, in the description below, in order to easily distinguish operating devices, the alphabet allocated to the operating transmission apparatus 40 is written behind the reference numeral. For example, the filter 44a is a filter 44 included in the transmission apparatus 40a.

In operation S1 of FIG. 7, a packet for measuring is transmitted/received between a measuring unit 42a of the transmission apparatus 40a and a measuring unit 42b of the transmission apparatus 40b to measure quality a communication line between the transmission apparatus 40a and the transmission apparatus 40b. The measuring of the communication quality is performed with respect to both the protocol used in the communication apparatus 20 and the high-speed protocol. As the communication quality, for example, a round-trip delay time, a discard rate of the packet, and a throughput are measured.

In operation S2, the transmission policy generating unit 43 of the transmission apparatus 40a determines whether transmission of the packet from the communication apparatus 20 which may use the high-speed protocol uses the high-speed protocol based on the acquired communication quality to generate the transmission policy 51. Here, as the transmission policy 51, the packet sent to the TCP waiting port (#5100 port) of the application server 9 is transmitted without using the high-speed protocol.

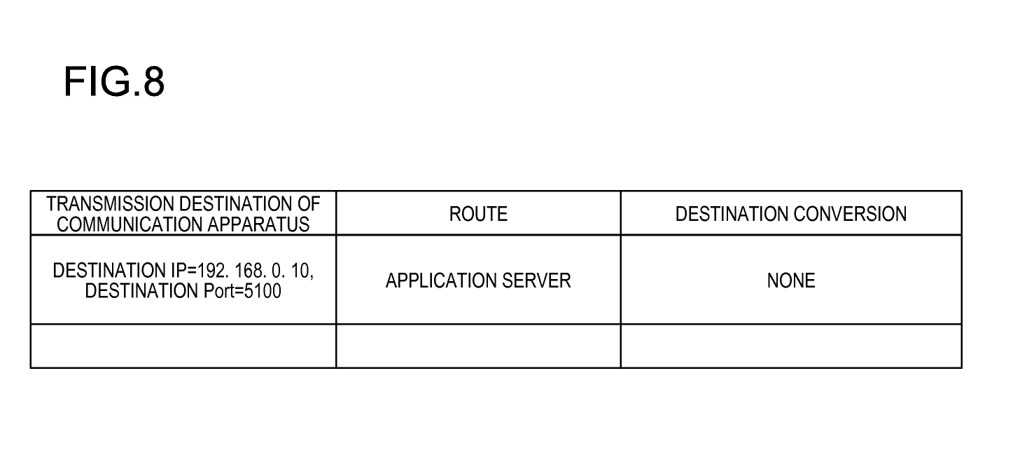

FIG. 8 is an example of the transmission policy 51. In the transmission policy 51, routing information and destination conversion information are associated for each transmission destination to which the communication apparatus 20 is accessible. The routing information is information which specifies an apparatus designated as a transmission destination of the packet to be transmitted to the transmission destination by the communication apparatus 20. The destination conversion information is address information which is used for transmitting, to an apparatus indicated in the routing information, the packet to be transmitted to the transmission destination by the communication apparatus 20. That is, the communication apparatus 20 assigns the transmission destination described as the destination conversion information as the transmission destination, in order to transmit a packet sent to an apparatus set in a column of the transmission destination to the apparatus indicated in the routing information. In an example of FIG. 8, route of the packet sent to the #5100 port of the application server 9 is set to the application server 9 and it is illustrated that the transmission destination may not be converted in the communication apparatus 20. Accordingly, when the transmission policy 51 of FIG. 8 is used, the packet transmitted to the application server 9 by the communication apparatus 20 is transmitted to the TCP thru without using the high-speed protocol.

In operation S3, the application processing unit 12 of the communication apparatus 20 generates the SYN packet in order to start communication with the application server 9. Here, the source IP address of the SYN packet is an address 192.168.1.10 of the communication apparatus 20 and the destination IP address is an address 192.168.0.10 of the application server 9. Further, a destination port number is set to No. 5100 of the TCP waiting port of the application server 9. The application processing unit 12 outputs the generated SYN packet to the distribution unit 21. The distribution unit 21 determines an output destination of the SYN packet by referring to the transmission policy table 35.

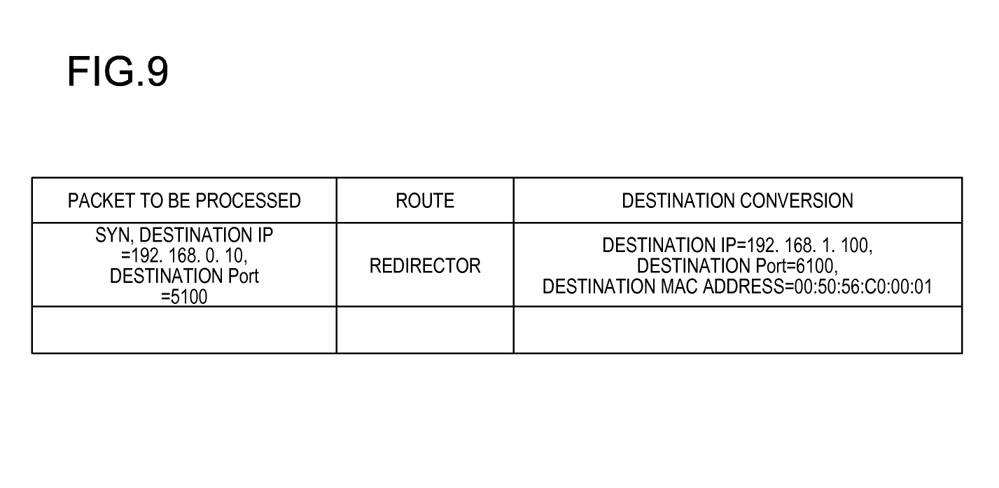

FIG. 9 illustrates an example of the transmission policy table 35. In the transmission policy table 35, with respect to a packet which may be a target of the transmission processing through the transmission apparatus 40, a change condition of the output destination and the transmission destination of the packet is written. The distribution unit 21 determines whether a condition applied to the packet to be processed exists in the transmission policy table 35 by setting a combination of information of the destination address, the destination port number, and the like of the packet to be processed as a key. In an example of FIG. 9, a first entry records that the SYN packet to the #5100 port of the application server 9 is output to the redirector 30. In addition, the distribution unit 21 outputs the packet to be processed to the duplication unit 31 according to output destination information of the first entry (operation S4).

The duplication unit 31 duplicates the input SYN packet to output one side to the forwarding processing unit 23 and the other side to the destination conversion unit 24 (operation S5).

In operation S6, the forwarding processing unit 23 sets a destination media access control (MAC) address of the input SYN packet in an address allocated to the NIC 65 of the transmission apparatus 40a. Through the process of the forwarding processing unit 23, the destination MAC address of the SYN packet is set to 00:50:56:C0:00:01. Meanwhile, since the destination IP address and the destination port of the SYN packet are not changed, the destination IP address is 192.168.0.10 allocated to the application server 9 and the destination port number is 5100. The forwarding processing unit 23 transmits the SYN packet after changing the MAC address to the transmission apparatus 40a as a packet for requesting the communication in the TCP thru. That is, the first request signal is transmitted to the transmission apparatus 40a by the process of the forwarding processing unit 23.

In operation S7, the filter 44a of the transmission apparatus 40a receives the first request signal through the interface unit 41a. The filter 44a determines that the communication based on the first request signal is not contrary to the transmission policy 51 (see FIG. 8) because the start of the communication to the #5100 port of the application server 9 from the communication apparatus 20 is requested by the first request signal. In addition, the filter 44a determines that the first request signal is transmitted to the application server 9. The filter 44a transmits the first request signal to the application server 9 through the interface unit 41a.

Next, a process of the SYN packet output to the destination conversion unit 24 from the duplication unit 31 will be described with reference to operation S8. The destination conversion unit 24 retrieves the transmission policy table 35 (see, e.g., FIG. 9) by setting the destination address and the destination port of the input SYN packet as a key. In the transmission policy table 35 illustrated in FIG. 9, in the first entry, with respect to the SYN packet to the #5100 port of the application server 9, the destination after conversion is set to the transmission apparatus 40a. In addition, the destination conversion unit 24 changes address information and port information of the SYN packet as follows.

Destination IP address=192.168.1.100 (transmission apparatus 40a)

Destination port=6100

Destination MAC address=00:50:56:C0:00:01

Source IP address=192.168.1.100 (communication apparatus 20)

Accordingly, the SYN packet input to the destination conversion unit 24 is converted into the SYN packet to the transmission apparatus 40a by changing the address. The destination conversion unit 24 transmits the packet after processing as the second request signal to the transmission apparatus 40a through the interface unit 25 (operation S8).

In operation S8, the filter 44a of the transmission apparatus 40a receives the second request signal through the interface unit 41a. The filter 44a refers to the accelerating target table 52 because the start of the communication to the transmission apparatus 40a from the communication apparatus 20 is requested by the second request signal.

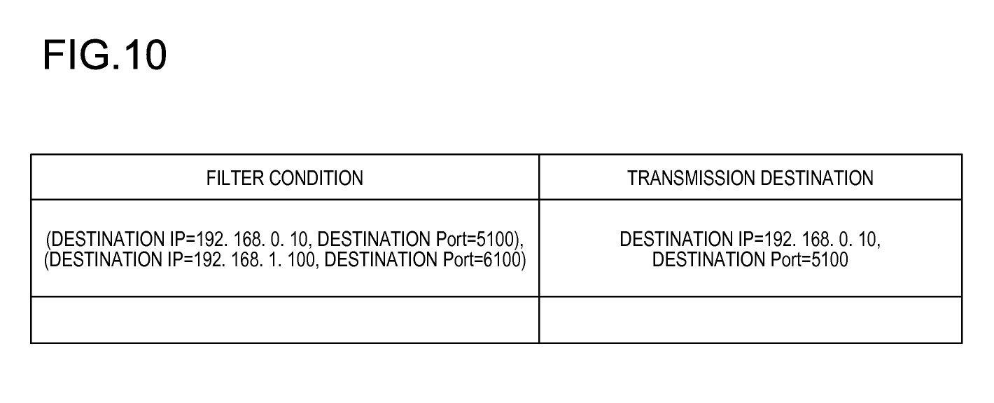

FIG. 10 is a diagram illustrating an example of an accelerating target table 52a. The accelerating target table 52 corresponds to the destination address and the destination port of the packet based on the first and second request signals in combination of the destination address and the destination port of the first and second request signals. A filter condition is a combination of the destination address and the destination port of the first and second request signals. Meanwhile, the column of the transmission destination is the destination address and the destination port of the packet based on the first and second request signals. That is, the filter 44a may specify whether the SYN packet (the second request signal) to its own apparatus is transmitted to correspond to the SYN packet to the other apparatus by referring to the accelerating target table 52a.

The filter 44a retrieves an entry having a filter condition including a combination of the destination address and the destination port of the second request signal from the accelerating target table 52a. The filter 44a specifies that the second request signal is generated based on the SYN packet to the #5100 port of the application server 9 by using the first entry of the accelerating target table 52.

The filter 44a specifies that the packet to the #5100 port of the application server 9 is not transmitted by using the high-speed protocol by referring to the transmission policy 51a (see FIG. 8). Then, the filter 44a transmits notification representing that the communication requested in the second request signal is not permitted, to the communication apparatus 20 as a response for the second request signal. In an example of FIG. 7, the filter 44a generates an RST packet sent to the communication apparatus 20 from the transmission apparatus 40a as the response for the second request signal. The filter 44a transmits the generated RST packet to the communication apparatus 20 through the interface unit 41a (operation S9).

In operation S10, the policy determining unit 32 of the communication apparatus 20 receives the RST packet through the interface unit 25. The policy determining unit 32 specifies the transmission destination corresponding to the transmission source of the RST packet by referring to the transmission policy table 35 (see, e.g., FIG. 9) when the RST packet is acquired. That is, the policy determining unit 32 specifies whether the communication with any apparatus passes through the transmission apparatus 40a or not by using the entry hit when the column of the destination conversion of the transmission policy table 35 is searched by setting the combination of the source IP address and the source port number of the RST packet as the key. The source IP address of the packet transmitted in operation S9 is #6100 port of 192.168.1.100. In addition, the policy determining unit 32 specifies that the high-speed protocol is not used in the communication of the #5100 port of the application server 9 (192.168.0.10) from the transmission policy table 35. The policy determining unit 32 memorizes that the packet other than the SYN packet to the #5100 port of the application server 9 is not transmitted to the transmission apparatus 40a, in the memory 62 as information which may be used by the distribution unit 21.

In operation S11, it is assumed that in response to the first request signal transmitted to the application server 9 from the transmission apparatus 40a, the permission of the communication from the application server 9 and the request of the communication to the communication apparatus 20 from the application server 9 are performed. Here, the ACK/SYN packet is transmitted to the communication apparatus 20 from the application server 9.

In operation S12, the application processing unit 12 of the communication apparatus 20 generates the ACK packet for permitting communication toward the communication apparatus 20 from the application server 9 with respect to the application server 9. The ACK packet generated from the application processing unit 12 is output to the distribution unit 21. Since the transmission destination of the ACK packet is the #5100 port of the application server 9, the distribution unit 21 specifies that the ACK packet is not transmitted to the transmission apparatus 40a by using the information acquired in the process of operation S10. In addition, the distribution unit 21 outputs the ACK packet to the interface unit 25. For this reason, the ACK packet to the #5100 port of the application server 9 is transmitted to the application server 9 without passing through the transmission apparatus 40a from the communication apparatus 20 as illustrated in operation S12. Thereafter, between the communication apparatus 20 and the application server 9, data communication starts without passing through the transmission apparatus 40a and the transmission apparatus 40b (operation S13).

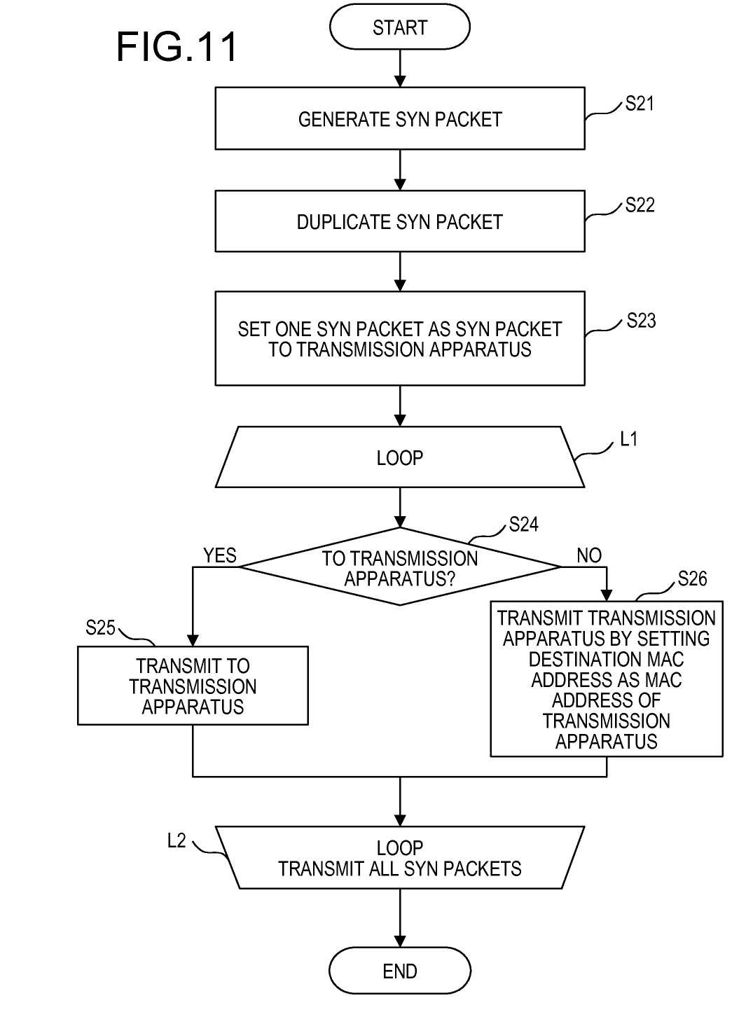

FIG. 11 is a flowchart for describing an example of a process performed by the communication apparatus 20 transmitting the SYN packet. Even in an example of FIG. 11, the transmission destination of the communication apparatus 20 is the application server 9.

The application processing unit 12 of the communication apparatus 20 generates the SYN packet to a transmission destination device when the communication starts (operation S21). The SYN packet is output to the duplication unit 31 through the distribution unit 21. The duplication unit 31 duplicates the input SYN packet (operation S22). One side of the duplicated SYN packet is changed into the SYN packet to the transmission apparatus 40a in order to request transmission processing using the high-speed protocol (operation S23). Alternatively, the other side of the SYN packet is targeted to the transmission processing of the SYN packet to the application server 9 as it is in order to request the start of the communication due to the TCP thru.

The communication apparatus 20 performs the transmission processing which is represented as the operation inserted into a loop terminal L1 and a loop terminal L2. To this end, the changed SYN packet to the transmission apparatus 40 is transmitted to the transmission apparatus 40 by the processing of the interface unit 25 and the like (Yes in operation S24, operation S25). Meanwhile, the SYN packet to the application server 9 is transmitted to the transmission apparatus 40 by the processing of the interface unit 25 and the like in the forwarding processing unit 23 after the destination MAC address is converted to the MAC address of the transmission apparatus 40 (No in operation S24, operation S26). When the transmission of both the SYN packet to the transmission apparatus 40 and the SYN packet to the application server 9 ends, the communication apparatus 20 ends the transmission processing of the SYN packet.

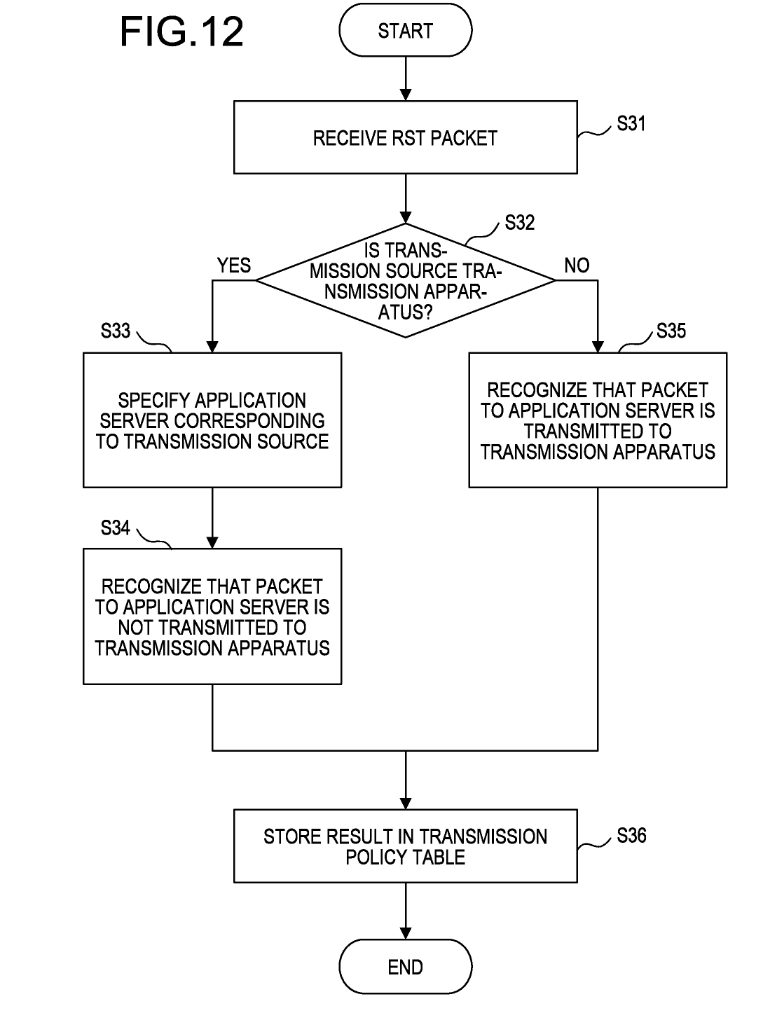

FIG. 12 is a flowchart for describing an example of a process performed by the transmission apparatus 40 receiving the RST packet. Here, the RST packet is a packet representing rejection of the communication for the communication requiring the start by the communication apparatus 20. The policy determining unit 32 determines the transmission source is the transmission apparatus 40 when the RST packet is received (operations S31 and S32). When the transmission source of the RST packet is the transmission apparatus 40, the policy determining unit 32 specifies the application server 9 corresponding to the transmission source of the RST packet by using the transmission policy table 35 (Yes in operation S32, operation S33). In addition, the policy determining unit 32 recognizes that a specific packet to the application server 9 is not transmitted to the transmission apparatus 40 and records the acquired result in the transmission policy table 35 (operations S34 and S36).

Meanwhile, when the transmission source of the RST packet is not the transmission apparatus 40, the policy determining unit 32 determines that the packet sent to the transmission source of the RST packet is transmitted by using the high-speed protocol (No in operation S32, S35). In addition, the policy determining unit 32 records in the transmission policy table 35, that the packet sent to the transmission source of the RST packet is transmitted to the transmission apparatus 40 (operation S36).

Meanwhile, in FIG. 12, the case where the information acquired from the RST packet is recorded in the transmission policy table 35 is described as an example, but as illustrated in FIG. 7, the transmission policy specified by using the RST packet may be cached in the memory 62.

As such, the transmission apparatus 40 notifies rejection of the communication to the communication apparatus 20 with respect to a signal which is contrary to the content of the transmission policy 51 of the first and second request signals transmitted to the transmission apparatus 40 from the communication apparatus 20. For this reason, when the communication due to the TCP thru between the communication apparatus 20 and the application server 9 is determined by the transmission apparatus 40, the communication apparatus 20 may acquire rejection of the communication for the second request signal to acquire the transmission policy. Further, even though the communication apparatus 20 starts the communication without waiting acquisition of the transmission policy determined in the transmission apparatus 40, the communication apparatus 20 may start communication suitable for the transmission policy.

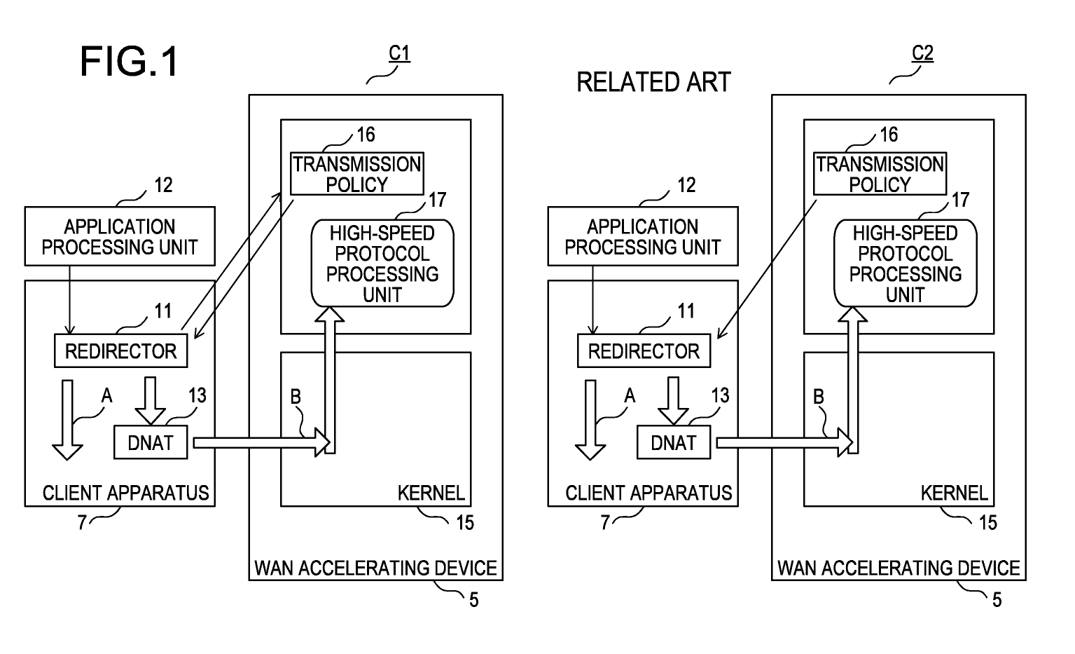

Accordingly, according to the first embodiment, it is possible to shorten a time taken to establish the communication. For example, in the case of case C1 illustrated in FIG. 1, a time ΔT1 taken to establish the communication becomes a sum of a time TI taken to inquire the transmission policy and a time TC taken for a three-way hand shake. Meanwhile, in the method according to the first embodiment, a time ΔT2 taken to establish the communication may be close to the time TC taken for a three-way hand shake. Here, since the time taken to inquire the transmission policy is close to the RTT, establishment of one access is earlier than an accessing process using the case C1 by the RTT by using the first embodiment. For example, in the case of a web browsing, since the TCP connection is established whenever a page is read, the establishment of the TCP connection generated when the page is read may be speed-enhanced by using the first embodiment.

In the first embodiment, the communication apparatus 20 does not inquire the transmission policy 51 in the transmission apparatus 40 to reduce a data amount transmitted by the communication apparatus 20 for establishment of the communication. For example, like the case C1 of FIG. 1, in the case of inquiry, a data amount dl required for inquiry is 300 bytes. Any one of the SYN packet and the ACK packet is 64 bytes, and 37 sections per page are generated when the page is read in the web browsing. Then, in the case C1, a control data amount D1 transmitted/received for reading one page may be calculated as follows.

$$\begin{matrix}D 1 = ( d 1 + SYN + ACK ) \times 37 \\ = ( 300 + 64 + 64 ) \times 37 \\ = 15837 bytes\end{matrix}$$

Meanwhile, an amount D2 of control data transmitted/received when using the first embodiment is as follows.

$$\begin{matrix}D 2 = ( SYN \times 2 + ACK ) \times 37 \\ = ( 64 \times 2 + 64 ) \times 37 \\ = 7104 bytes\end{matrix}$$

Therefore, according to the first embodiment, the control data of two times or more is reduced as compared with the case C1. Further, as in a communication method illustrated in case C2 of FIG. 2, there is no possibility to disconnect the communication by affecting the established TCP connection.

Meanwhile, in the first embodiment, since the communication apparatus 20 does not transmit the packet transmitted by the TCP thru to the transmission apparatus 40a, a processing load of the transmission apparatus 40a may be reduced. When the communication apparatus 20 redirects all the packets to the transmission apparatus 40a, the packet performing the TCP thru is transmitted to the transmission apparatus 40a. In this case, the target packet of the TCP thru is transmitted as the packet to the application server 9 by the filter 44a. However, when the transmission apparatus 40a is not included in a shortest route from the communication apparatus 20 to the application server 9, by the redirect to the transmission apparatus 40a, a waste of the communication occurs and a load of the transmission apparatus 40a is increased. According to the first embodiment, since the packet of the TCP thru is not transmitted from the communication apparatus 20 to the transmission apparatus 40a, the communication efficiency is good and the load of the transmission apparatus 40a is decreased.

### Second Embodiment

In the second embodiment, an example of processing in a case determined that a packet transmitted/received between the communication apparatus 20 and the application server 9 is transmitted by using the high-speed protocol will be described. Meanwhile, in the second embodiment, a case where the forwarding processing unit 23 uses a tunnel in order to transmit the SYN packet (first request signal) to the application server 9 to the transmission apparatus 40a will be exemplified. Hereinafter, the case where the forwarding processing unit 23 transmits the first request signal to the transmission apparatus 40a by using a generic routing encapsulation (GRE) tunnel is described as an example, but the first request signal may be transmitted to the transmission apparatus 40a by tunneling other than the GRE.

Meanwhile, in the second embodiment, for easy illustration, the IP address allocated to the transmission apparatus 40a may be written as WA-C and the IP address allocated to the communication apparatus 20 may be written as APL CL. Similarly, the IP address allocated to the application server 9 may be written as APL SV.

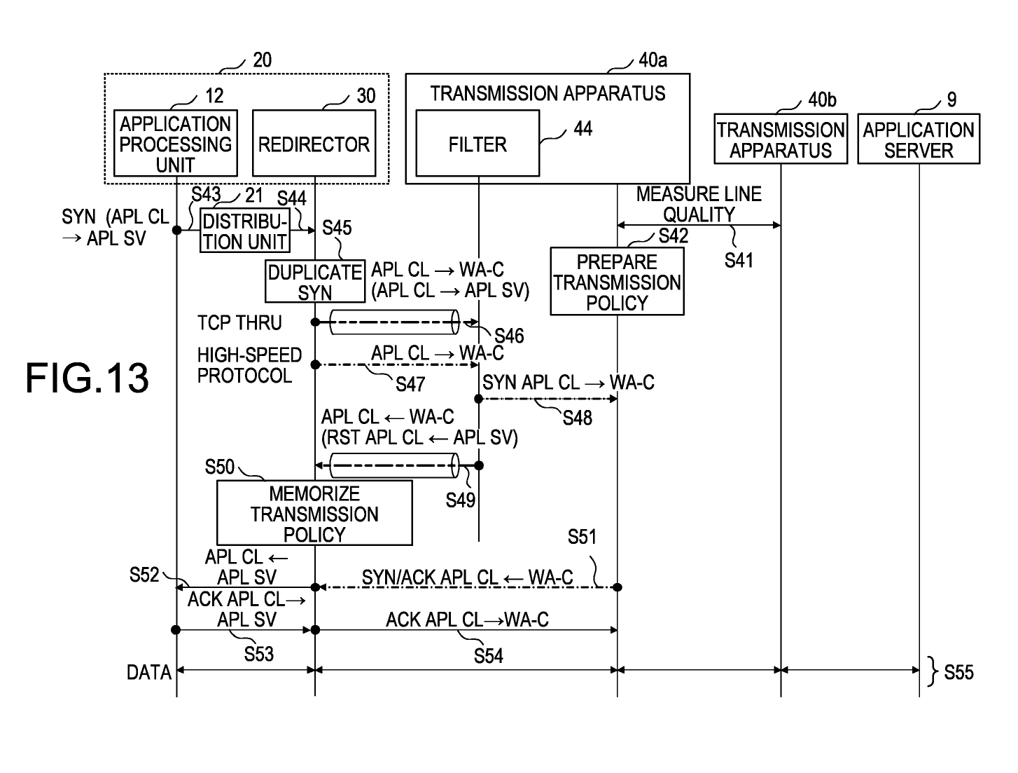

FIG. 13 is a sequence diagram illustrating an example of communication processing performed in the second embodiment. Processing performed in operations S41 and S42 is similar to the processing described with reference to operations 51 and S2 of FIG. 7.

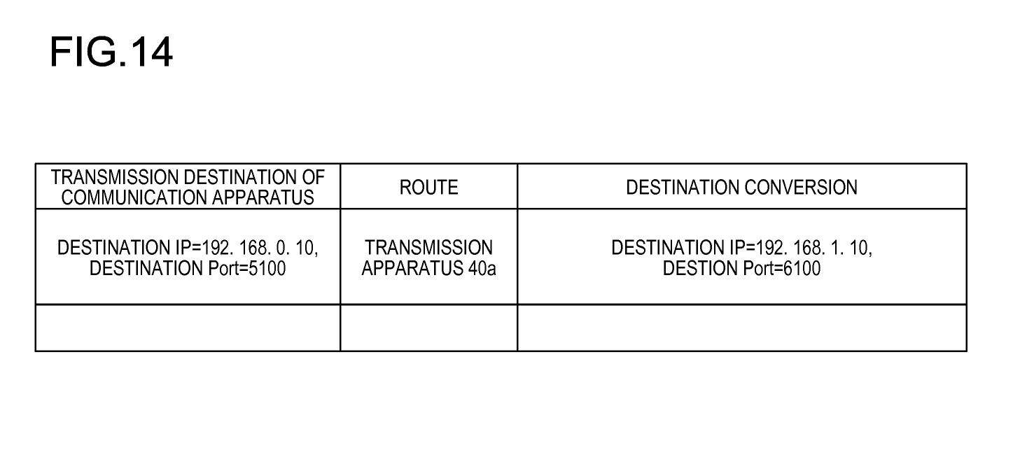

FIG. 14 illustrates an example of the transmission policy 51 used in the second embodiment. In the example of FIG. 14, route of the packet sent to the #5100 port of the application server 9 is set in the transmission apparatus 40a. In the transmission policy 51 of FIG. 14, it is indicated that the transmission destination of the packet to the #5100 port of the application server 9 is converted into the #6100 port of the transmission apparatus 40a (192.168.1.10) in the communication apparatus 20. Accordingly, when the transmission policy 51 of FIG. 14 is used, the packet transmitted to the application server 9 by the communication apparatus 20 is transmitted by using the high-speed protocol via the transmission apparatus 40a.

Processing performed in operations S43 to S45 is similar to the processing described with reference to operations S3 to S5 of FIG. 7. Meanwhile, in the SYN packet generated in operation S43, the transmission destination is the #5100 port of the application server 9. Thereafter, similarly to the first embodiment, the forwarding processing unit 23 acquires from the duplication unit 31 the first request signal for requesting the communication by the TCP thru. The forwarding processing unit 23 encapsulates the first request signal.

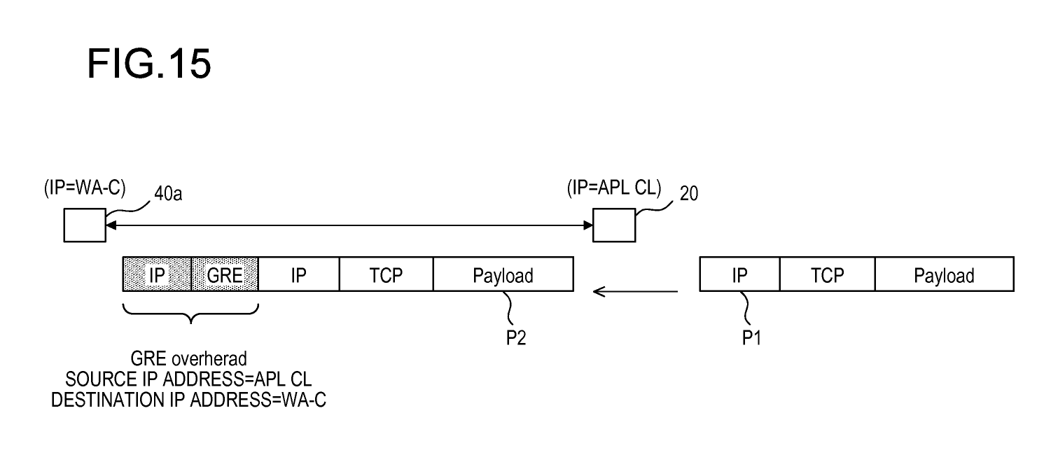

FIG. 15 illustrates an example of a format of a packet transmitted through the GRE tunnel. An example P1 of the format of the first request signal is illustrated in FIG. 15 as a comparison target. As illustrated in P1, the first request signal includes an IP header, a TCP header, and a payload. The forwarding processing unit 23 attaches a GRE header and an IP header to a front of the IP header of the first request signal as illustrated in P2. In the following description, the IP header included in P1 may be referred to as ‘inner header’ and an IP header added while tunneling may be referred to as ‘outer header’ for easy distinguishment.

Meanwhile, the destination IP address of the outer header is the address (WA-C) of the transmission apparatus 40a and the source IP address is the address (APL-CL) of the communication apparatus 20. Meanwhile, the destination IP address of the inner header is the address (APL SV) of the application server 9 and the source IP address is the address (APL CL) of the communication apparatus 20. Further, it is assumed that the destination port number of the first request signal is 5100.

In operation S46, since the forwarding processing unit 23 transmits the encapsulated packet, the encapsulated first request signal is transmitted to the transmission apparatus 40a. The filter 44a of the transmission apparatus 40a decapsulates the received packet to acquire the first request signal.

Meanwhile, the destination conversion unit 24 generates the second request signal from the SYN packet to transmit the second request signal to the transmission apparatus 40a (operation S47). Processing performed in this case is similar to the processing described with reference to operation S8 of FIG. 7. The filter 44a specifies that the packet to the #5100 port of the application server 9 is transmitted by the high-speed protocol by using the transmission policy 51 illustrated in FIG. 14. As a result, the filter 44a outputs the second request signal to a proxy processing unit 45a (operation S48).

Subsequently, processing of the first request signal by the filter 44a will be described. The transmission destination of the first request signal is the #5100 port of the application server 9. The filter 44a specifies that the packet to the #5100 port of the application server 9 is transmitted by the high-speed protocol from the transmission policy 51 illustrated in FIG. 14. Therefore, the filter 44a generates an RST packet having the following address information and port information as a rejection notification for notifying rejection of the start of the communication with respect to the first request signal.

Source IP address=192.168.0.10 (application server 9)

Source port=5100

Destination IP address=192.168.1.100 (communication apparatus 20)

That is, the filter 44a of the transmission apparatus 40a generates a rejection notification including the same information as a case in which the application server 9 as the transmission destination of the first request signal rejects the communication using the first request signal. The filter 44a transmits the generated RST packet to the communication apparatus 20 (operation S49). Meanwhile the destination address of the RST packet is an address of the communication apparatus 20 and the source address is an address of the application server 9. As a result, the RST packet may be transmitted via the GRE tunnel and further, transmitted to the communication apparatus 20 without bypassing the GRE tunnel.

In operation S50, the policy determination unit 32 of the communication apparatus 20 receives the RST packet for the first request signal through the interface unit 25. The policy determination unit 32 determines that the transmission processing using the high-speed protocol of the packet to the #5100 port of the application server 9 is performed when acquiring the RST packet to cache the following information to the memory 62.

Transmission destination
Destination address=192.168.0.10 (application server 9)
Destination port=5100

Routing information: Transmission apparatus 40a

Destination conversion
Destination address after conversion=192.168.1.100 (transmission apparatus 40a)
Destination port after conversion=6100
Destination MAC address after conversion=00:50:56:C0:00:01

In operation S51, the proxy processing unit 45a of the transmission apparatus 40a transmits a control signal for permitting communication for the second request signal input from the filter 44a and requesting communication to the communication apparatus 20 from the transmission apparatus 40a. In the example of FIG. 13, it is assumed that the proxy processing unit 45a transmits an ACK/SYN packet to the communication apparatus 20 from the transmission apparatus 40a. Meanwhile, the ACK/SYN packet transmitted in operation S51, the source address is the address (192.168.1.100) of the transmission apparatus 40a and the source port is the #6100 port.

Since the SYN/ACK packet transmitted in operation S51 is the packet transmitted to the communication apparatus 20 from the transmission apparatus 40a, the SYN/ACK packet is output to the source conversion unit 26. The source conversion unit 26 refers to the source conversion table 36 in order to process the input packet.

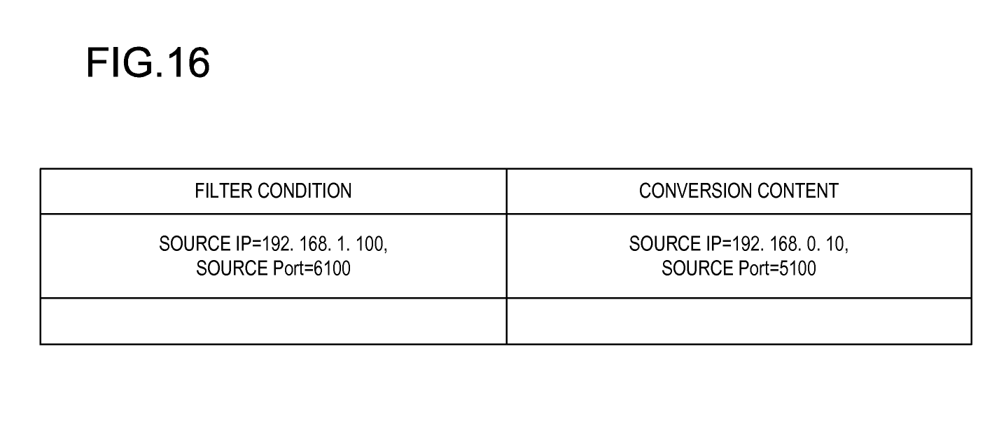

FIG. 16 is a diagram illustrating an example of the source conversion table 36. The source conversion table 36 includes a filter condition and a conversion content. The source conversion unit 26 changes the source IP address and the source port number of the packet by using a conversion content corresponding to a filter condition which matches a combination of the source IP address and the source port number of the packet to be processed. In the example of FIG. 16, changing the transmission source of the packet transmitted from the #6100 port of the transmission apparatus 40a to the #5100 port of 192.168.0.10 (application server 9) is written in the source conversion table 36. The source conversion unit 26 changes the transmission source of the SYN/ACK packet to the #5100 port of the application server 9 by using the source conversion table 36. The source conversion unit 26 outputs the SYN/ACK packet to the application processing unit 12 when the change processing of the transmission source ends (operation S52).

The application processing unit 12 determines that the permission of the communication with the #5100 port of the application server 9 and the request for the communication to the communication apparatus 20 from the application server 9 are performed by the SYN/ACK packet input in operation S52. Therefore, the application processing unit 12 generates the ACK packet sent to the application server 9 from the communication apparatus 20 in order to permit the communication to the communication apparatus 20 from the application server 9. The application processing unit 12 outputs the generated ACK packet to the distribution unit 21. The distribution unit 21 uses the transmission policy cached in operation S50 in order to specify an output destination of the input ACK packet. Herein, since the routing information of the cached information is the transmission apparatus 40a, the distribution unit 21 outputs the ACK packet to the destination conversion unit 22 (operation S53). The destination conversion unit 22 changes the transmission destination of the input packet to the #6100 port of the transmission apparatus 40a (192.168.1.100) by using the cached transmission policy. The packet processed in the destination conversion unit 22 is transmitted to the transmission apparatus 40a (operation S54). On this account, a bidirectional connection is established, which the communication apparatus 20 and the application server 9 use to perform the communication processing using the high-speed protocol. Thereafter, communication is performed between the communication apparatus 20 and the application server 9 by using the established connection (operation S55). Meanwhile, in the communication of operation S55, a packet transmitted and received between the communication apparatus 20 and the application server 9 is transmitted by using the high-speed protocol.

As such, the transmission apparatus 40 notifies that the communication is not permitted as a response to the first request signal when processing the packet transmitted and received between the communication apparatus 20 and the application server 9 by using the high-speed protocol. As a result, it may be specified that the communication apparatus 20 acquires the rejection of the communication of the first request signal to transmit the packet to the application server 9 to the transmission apparatus 40. Further, similarly to the first embodiment, even though the communication apparatus 20 starts the communication without waiting acquisition of the transmission policy decided in the transmission apparatus 40, the communication apparatus 20 may start communication suitable for the transmission policy and also reduce transmitted and received control data.

### Third Embodiment

In a third embodiment, a case in which a plurality of IP addresses is allocated to the transmission apparatus 40 and in communication using the TCP thru and the high-speed protocol, a destination IP address of a start request of the communication is different will be described. In this case, the communication apparatus 20 recognizes an address which becomes a transmission destination of the start request of the communication in the TCP thru and an address which becomes the transmission destination of the start request of the communication in the communication using the high-speed protocol in advance.

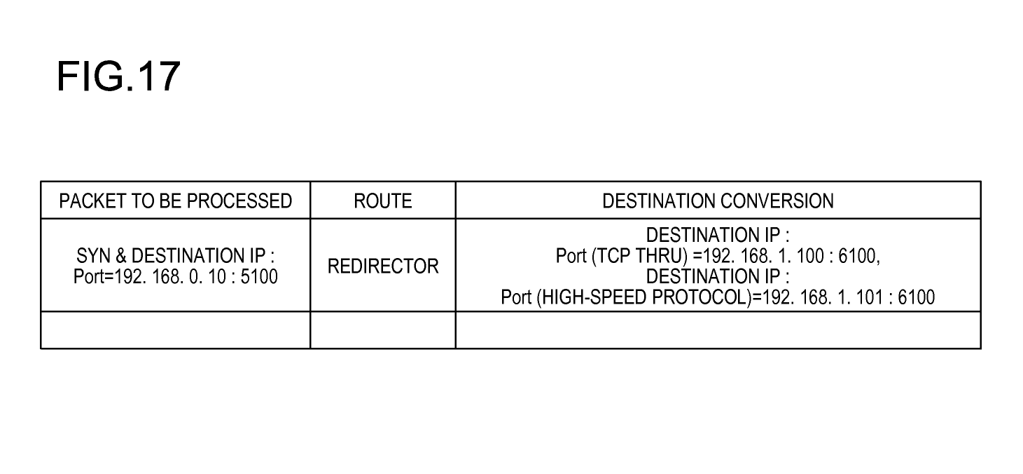

FIG. 17 illustrates an example of the transmission policy table 35 used in the third embodiment. Routing information and a conversion content of the transmission destination correspond to a packet to be processed and herein, as the conversion content of the transmission destination, two types of a transmission destination for the TCP thru and a transmission destination for transmission using the high-speed protocol are set. In the following example, it is assumed that a packet (first request signal) for performing the TCP thru among SYN packets to the #5100 port of the application server 9 (192.168.0.10) is transmitted to the #6100 port of 192.168.1.100. Meanwhile, it is assumed that the SYN packet (second request signal) for requesting starting the transmission using the high-speed protocol is transmitted to the #6100 port of 192.168.1.101.

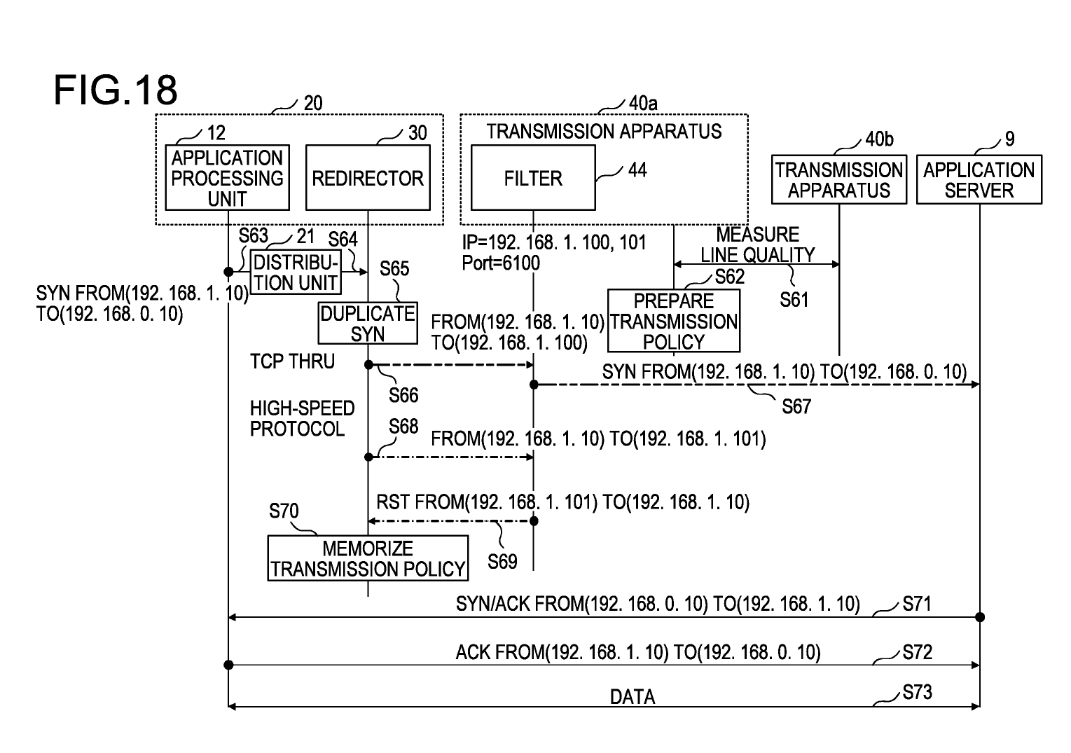

FIG. 18 is a sequence diagram illustrating an example of communication processing performed in the third embodiment. Processing performed in operations S61 to S65 is similar to processing described with reference to operations S1 to S5 of FIG. 7. Meanwhile, in operation S63, it is assumed that the application processing unit 12 generates a SYN packet having the following address information and port information in order to request starting the communication to the application server 9.

Destination IP address=192.168.0.10 (application server 9)

Destination port number=5100

Source IP address=192.168.1.10 (communication apparatus 20)

Source port number=49000

Thereafter, similarly to the first and second embodiments, the forwarding processing unit 23 acquires from the duplication unit 31 the first request signal for requesting the communication by the TCP thru. The forwarding processing unit 23 converts the destination IP address and the destination port number of the input packet into an address and a port allocated to the transmission apparatus 40a for the TCP thru by using the transmission policy 51 to generate the first request signal. As a result, in the packet (first request signal) after converting the transmission destination, the address information and the port information will be described below.

Destination IP address=192.168.1.100 (TCP thru)

Destination port number=6100

Source IP address=192.168.1.10 (communication apparatus 20)

Source port number=49000

The forwarding processing unit 23 transmits the first request signal to the transmission apparatus 40a (operation S66).

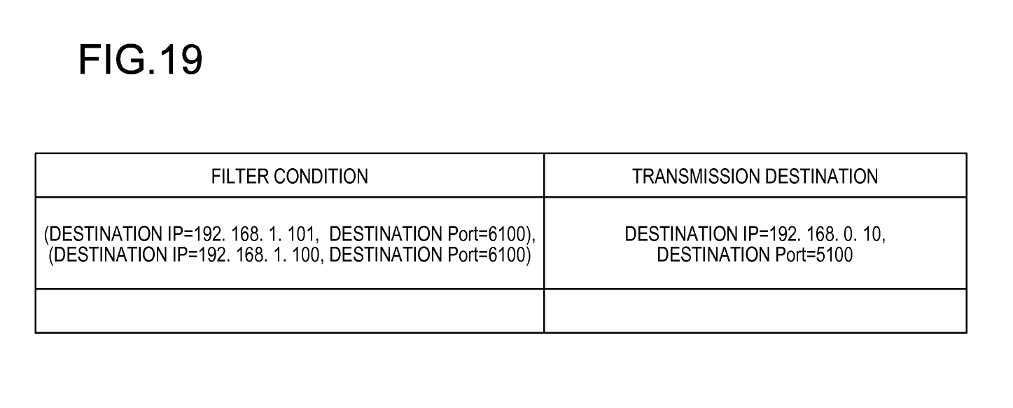

FIG. 19 illustrates an example of an accelerating target table 52a used in the third embodiment. The accelerating target table 52a makes combinations of the destination address and the destination ports of the first and second request signals correspond to information of the transmission destination which the communication apparatus 20 requests the start by using the first and second request signals. In the third embodiment, by the accelerating target table 52a, the combination of the address and the port allocated to the application server 9 of the transmission destination corresponds to the destination port number of the SYN packet. For example, the SYN packet of the destination port number=6100 is a SYN packet for requesting starting the communication for the #5100 port of the application server 9.

The filter 44a determines that the start of the communication for the #5100 port of the application server 9 is requested by the information of the accelerating target table 52a. Further, the filter 44a memorizes that 192.168.1.100 is the address used for the request for the communication using the TCP thru in advance.

Herein, it is assumed that the transmission policy 51a is similar to the transmission policy 51a illustrated in FIG. 8. Then, the filter 44a changes and records the destination information of the first request signal to the #5100 port of the application server 9 so as to perform the communication by the TCP thru. That is, by the processing in the filter 44a, the SYN packet including the following address information and port information is transmitted to the application server 9 (operation S67).

Destination IP address=192.168.0.10 (application server 9)

Destination port number=5100

Source IP address=192.168.1.10 (communication apparatus 20)

Source port number=49000

Meanwhile, in the communication apparatus 20, the destination conversion unit 24 generates the second request signal by using the transmission policy table 35 (FIG. 17). In the second request signal, since the address and the port allocated to the transmission apparatus 40a, which is used for the communication using the high-speed protocol are designated in the transmission destination, the address information and the port information in the second request signal will be described below.

Destination IP address=192.168.1.101 (high-speed protocol)

Destination port number=6100

Source IP address=192.168.1.10 (communication apparatus 20)

Source port number=49000

In operation S68, the destination conversion unit 24 transmits the second request signal to the transmission apparatus 40a.

The filter 44a of the transmission apparatus 40a determines that the start of the communication for the #5100 port of the application server 9 is requested by using the accelerating target table 52a (FIG. 19) when receiving the second request signal. Further, the filter 44a memorizes that 192.168.1.101 is the address used for the request for the communication using the high-speed protocol in advance. Based on the information, the filter 44a specifies that the packet to the #5100 port of the application server 9 is transmitted to the TCP thru by using the transmission policy 51a (see, e.g., FIG. 8). Therefore, the filter 44a decides that the communication requested in the second request signal is not permitted and notifies rejection of the communication to the communication apparatus 20. Herein, it is assumed that an RST packet including the following address and port information is transmitted to the communication apparatus 20 (operation S69).

Destination IP address=192.168.1.10 (communication apparatus 20)

Destination port number=49000

Source IP address=192.168.1.101 (high-speed protocol)

Source port number=6100

Processing performed in operations S70 to S73 is similar to the processing performed in operations S10 to S13 described with reference to FIG. 7.

As such, in the third embodiment, since the first request signal and the second request signal have different IP addresses as the transmission destinations, the filter 44 may distinguish the first request signal and the second request signal by using the destination addresses. Further, since either of the first and second request signals sets the address allocated to the transmission apparatus 40 in the transmission destination, both the first and second request signals are transmitted to the transmission apparatus 40. In addition, similarly to the first embodiment, a time required for communication establishment may be shortened or transmitted/reception control data may also be reduced.

### Fourth Embodiment

In the fourth embodiment, in the transmission apparatus 40, a case will be described in which the TCP waiting ports are different in the communication using the TCP thru and the communication using the high-speed protocol. In this case, the communication apparatus 20 recognizes a destination port of the start request of the communication in the TCP thru and a destination port of the start request of the communication in the communication using the high-speed protocol in advance.

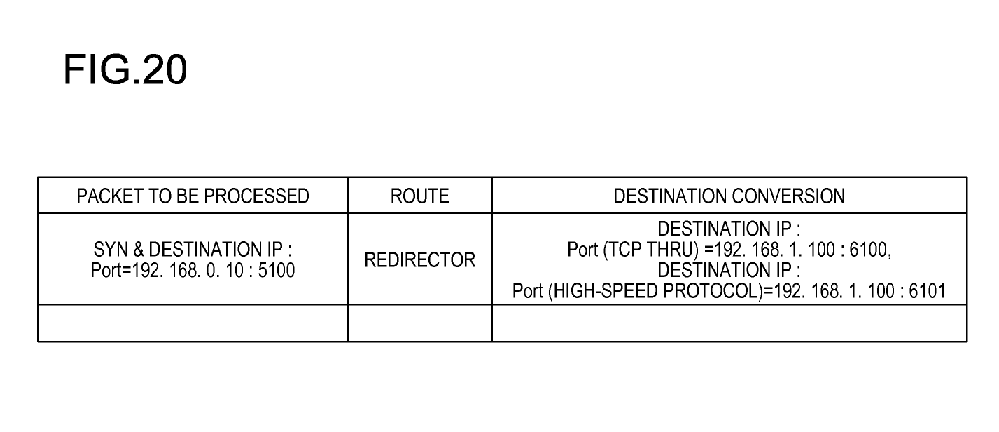

FIG. 20 illustrates an example of the transmission policy table 35 used in the fourth embodiment. Even in the transmission policy table 35 used in the fourth embodiment, two types of the transmission destination for the TCP thru and the transmission destination for the transmission using the high-speed protocol are set to correspond to packets to be processed. In the following example, it is assumed that a packet (first request signal) for performing the TCP thru among SYN packets to the #5100 port of the application server 9 (192.168.0.10) is transmitted to the #6100 port of 192.168.1.100. Meanwhile, it is assumed that the SYN packet (second request signal) for requesting starting the transmission using the high-speed protocol is transmitted to the #6101 port of 192.168.1.100.

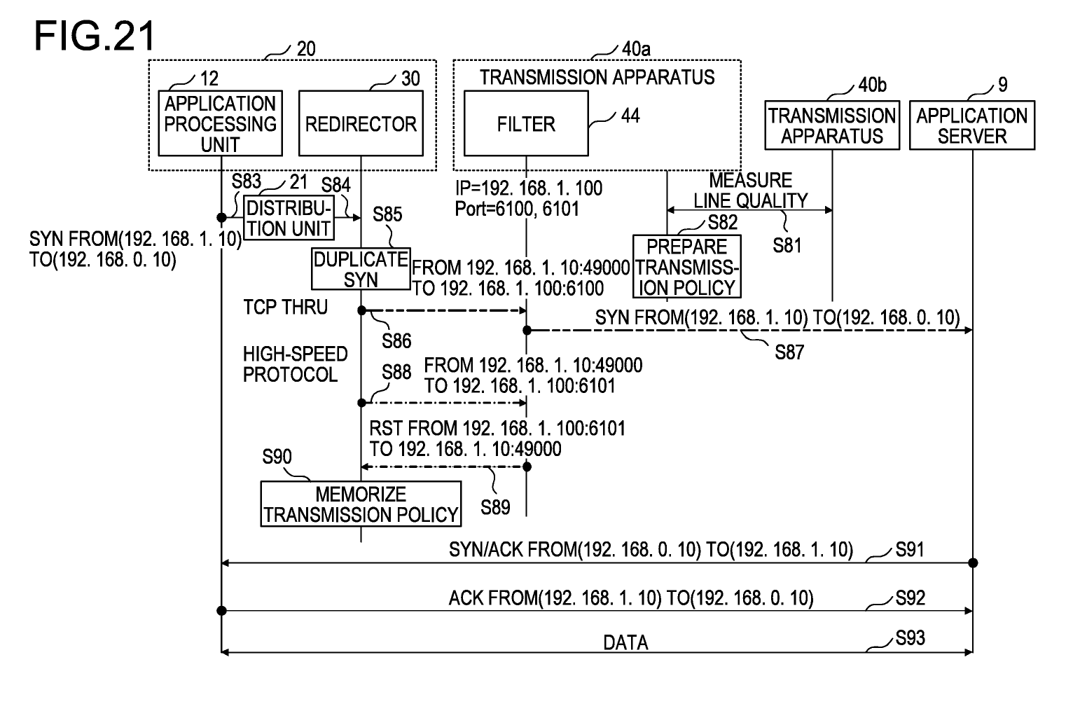

FIG. 21 is a sequence diagram illustrating an example of communication processing performed in the fourth embodiment. Processing performed in operations S81 to S85 is similar to the processing described with reference to operations S1 to S5 of FIG. 7.

Thereafter, similarly to the first to third embodiments, the forwarding processing unit 23 acquires the SYN packet from the duplication unit 31. The forwarding processing unit 23 converts the transmission destination of the SYN packet into an address and a port allocated to the transmission apparatus 40a for the TCP thru by using the transmission policy 51 to generate the first request signal. As a result, in the first request signal, the address information and the port information will be described below.

Destination IP address=192.168.1.100 (transmission apparatus 40a)

Destination port number=6100 (TCP thru)

Source IP address=192.168.1.10 (communication apparatus 20)

Source port number=49000

The forwarding processing unit 23 transmits the first request signal to the transmission apparatus 40a (operation S86).

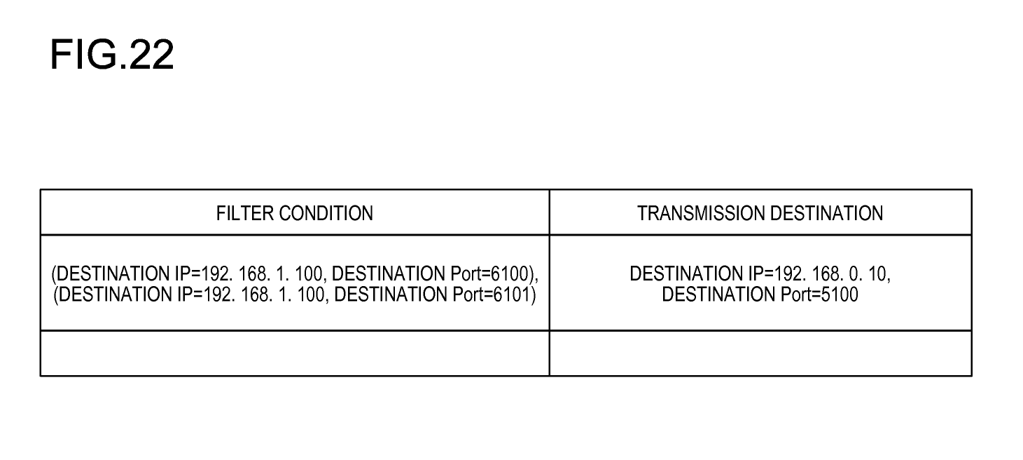

FIG. 22 illustrates an example of the accelerating target table 52a used in the fourth embodiment. The filter 44a determines that the SYN packet in which the destination address is 192.168.1.100, the destination port is #6100 or 6101 requests communication with the #5100 port of the application server 9 by using the accelerating target table 52a illustrated in FIG. 22.

The filter 44a determines that the start of the communication for the #5100 port of the application server 9 is requested by the information of the accelerating target table 52a. Further, the filter 44a memorizes that the #6100 port is the address used for the request for the communication using the TCP thru in advance.

Herein, it is assumed that the transmission policy 51a is similar to the transmission policy 51a illustrated in FIG. 8. Then, the filter 44a transmits the first request signal to the application server 9 so as to perform the communication by the TCP thru. Meanwhile, the filter 44a changes the address of the first request signal as follows when transmitting the first request signal (operation S87).

Destination IP address=192.168.0.10 (application server 9)

Destination port number=5100

Source IP address=192.168.1.10 (communication apparatus 20)

Source port number=49000

Meanwhile, in the communication apparatus 20, the destination conversion unit 24 generates the second request signal by using the transmission policy table 35 (see. e.g., FIG. 20). In the second request signal, the address and the port allocated to the transmission apparatus 40a, which is used for the communication using the high-speed protocol are used for the transmission destination. As a result, in the second request signal, the address information and the port information will be described below.

Destination IP address=192.168.1.100 (transmission apparatus 40a)

Destination port number=6101 (high-speed protocol)

Source IP address=192.168.1.10 (communication apparatus 20)

Source port number=49000

In operation S88, the destination conversion unit 24 transmits the second request signal to the transmission apparatus 40a.

The filter 44a of the transmission apparatus 40a determines that the start of the communication using the high-speed protocol for the #5100 port of the application server 9 is requested by using the accelerating target table 52a (see, e.g., FIG. 22) when receiving the second request signal. Further, the filter 44a specifies that the packet to the #5100 port of the application server 9 is transmitted to the TCP thru by using the transmission policy 51a (see, e.g., FIG. 8). Therefore, the filter 44a transmits the RST packet including the following address and port information to the communication apparatus 20 with respect to the communication apparatus 20 as a response to the second request signal (operation S89).

Destination IP address=192.168.1.10 (communication apparatus 20)

Destination port number=49000

Source IP address=192.168.1.100 (transmission apparatus 40a)

Source port number=6101 (high-speed protocol)

Processing performed in operations S90 to S93 is similar to the processing performed in operations S10 to S13 described with reference to FIG. 7.

As such, in the fourth embodiment, since the first request signal and the second request signal have different destination port numbers, the filter 44 may distinguish the first request signal and the second request signal by using the destination port numbers. In addition, similarly to the first embodiment, a time required for communication establishment may be shortened or transmitted/reception control data may also be reduced.

Others

Meanwhile, the embodiment is not limited thereto and may be modified to various embodiments. Hereinafter, several examples will be described.

In the second embodiment, the case in which the transmission processing is performed by using the high-speed protocol has been described as an example, but even when the communication by the TCP thru is performed, the transmission processing from the communication apparatus 20 to the transmission apparatus 40a may be performed by using a tunnel. In the case of the TCP thru, the transmission apparatus 40a does not permit the start of the communication requested in the signal (second request signal) for the communication apparatus 20 to request the start of the communication with the application server 9 through the transmission apparatus 40a.

Even in the first, third, and fourth embodiments, when the communication using the high-speed protocol is performed, the filter 44a does not permit the start of the communication requested in the signal (first request signal) to request the start of the communication with the application server 9, similarly to the second embodiment.

The information element of the table or message is one example and the information element may be changed depending on mounting.

Meanwhile, in the above description, the case in which the transmission destination of the communication apparatus 20 is the application server 9 has been described, but the communication apparatus 20 may perform the same manner of processing even in communication with another apparatus. Further, the application server 9 of the transmission destination transmits first and second communication requests to the transmission apparatus 40b similarly to the communication apparatus 20 to efficiently perform communication processing.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication system, comprising:
a communication apparatus configured to generate a first request signal and a second request signal, each requesting a start of a communication with a transmission destination; and
a transmission apparatus configured to transmit a packet to be transmitted from the communication apparatus to the transmission destination,
wherein the communication apparatus transmits the first request signal and the second request signal to the transmission apparatus, the second request signal requesting the start of the communication with the transmission destination with passing through the transmission apparatus, and
wherein, when a request of the first request signal is permitted,
the transmission apparatus notifies the communication apparatus of that a request of the second request signal is not permitted, and transmits the first request signal to the transmission destination, and
the communication apparatus receives a response to the first request signal from the transmission destination and starts communication with the transmission destination without passing through the transmission apparatus.

2. The communication system according to claim 1,
wherein, when the request of the second request signal is permitted,
the transmission apparatus transmits, to the communication apparatus, a first notification signal for representing that the request of the first request signal is not permitted and a second notification signal for representing that the request of the second request signal is permitted, the first notification signal including a transmission source address to which an address of the transmission destination is set,
the communication apparatus receives the second notification signal from the transmission apparatus and transmits a packet to be transmitted to the transmission destination to the transmission apparatus, and
the transmission apparatus transmits the packet to the transmission destination.

3. The communication system according to claim 1,
wherein, when the communication apparatus generates the first request signal, the communication apparatus duplicates the first request signal, and generates the second request signal by converting first identification information including a combination of a destination address and a destination port number of the duplicated first request signal into second identification information including a combination of an address and a port number allocated to the transmission apparatus, and
wherein the transmission apparatus maintains corresponding information corresponding to the first identification information and the second identification information for each connection generated between the communication apparatus and the transmission destination, and specifies the transmission destination which the communication apparatus requests the start of the communication by the second request signal, based on the corresponding information.

4. The communication system according to claim 2,
wherein the communication apparatus
determines that the request of the first request signal is not permitted when the first notification signal includes the transmission source address to which the address of the transmission destination is set, and
determines that the request of the second request signal is not permitted when a third notification signal for representing that the request of the second request signal is not permitted includes a transmission source address to which an address of the transmission apparatus is set.

5. A communication method in a communication system including a communication apparatus communicating with a transmission destination and a transmission apparatus transmitting a packet transmitted from the communication apparatus to the transmission destination, the communication method comprising:
transmitting, to the transmission apparatus, a first request signal for requesting a start of the communication with the transmission destination and a second request signal for requesting a start of the communication with the transmission destination with passing through the transmission apparatus, by the communication apparatus;
when a request of the first request signal is permitted,
notifying the communication apparatus of that a request of the second request signal is not permitted and transmitting the first request signal to the transmission destination, by the transmission apparatus; and
receiving a response to the first request signal from the transmission destination with respect to the first request signal and starting communication with the transmission destination without passing through the transmission apparatus, by the communication apparatus.

6. A transmission apparatus configured to transmit a packet to be transmitted to a transmission destination from a communication apparatus configured to communicate with the transmission destination, the transmission apparatus comprising:
a communication unit configured to receive a first request signal for requesting a start of the communication with the transmission destination and a second request signal for requesting a start of the communication with the transmission destination with passing through the transmission apparatus, each of the first request signal and the second request signal being transmitted from the communication apparatus; and
a controller configured to notify the communication apparatus of that a request of the second request signal is not permitted and controls the first request signal to be transmitted to the transmission destination, when the communication apparatus communicates with the transmission destination based on a request of the first request signal.
